(19) United States
(12) Patent Application Publication
(10) Pub. No.: US 2019/0257719 A1
(43) Pub. Date: Aug. 22, 2019

(54) ABNORMAL-STATE DETECTION SYSTEM AND ABNORMAL-STATE DETECTION METHOD

(71) Applicant: HITACHI, LTD., Tokyo (JP)

(72) Inventors: Yoji Ozawa, Tokyo (JP); Yukinori Sakashita, Tokyo (JP)

(73) Assignee: HITACHI, LTD., Tokyo (JP)

(21) Appl. No.: 16/128,775

(22) Filed: Sep. 12, 2018

(30) Foreign Application Priority Data
Feb. 19, 2018 (JP) 2018-026714

(51) Int. Cl. G01M 99/00

(52) U.S. Cl. CPC G01M 99/005

(57) ABSTRACT

There is provided an abnormal-state detection system including: a processing execution unit that executes an application which performs information processing based on the received data after receiving the data sent from factory equipment; a data relation generation unit that generates a data association result which is information indicating the presence of relation between the data; an abnormal-state determination unit that determines whether or not the factory equipment is in an abnormal state which is a state other than a normal state which is a state where manufacturing of a product is actually performed, based on the data association result; a control unit that performs a control for preventing an influence of the application on the information processing based on a result of the determination; and a tag unit for tagging the data if the factory equipment is determined to be in the abnormal state.

### CROSS-REFERENCE TO RELATED APPLICATION

This application claims priority pursuant to 35 U.S.C. § 119 from Japanese Patent Application No. 2018-026714, filed on Feb. 19, 2018, the entire disclosure of which is incorporated herein by reference.

### BACKGROUND

The present invention relates to an abnormal-state detection system and an abnormal-state detection method.

JP-A-2010-244463 describes that “it is possible to uniquely identify events that are generated even when the event detection devices are different, and accordingly, event notification processing continues without leaking event notification among the plurality of event detection devices”, and “an event detection control method or a system for executing processing of notifying an application of an event message that displays notification contents if the generated data satisfies a notification condition, by a redundant configuration by the plurality of event detection devices including an operation system and a standby system, after comparing the generated data from the data generation device and event notification setting information including the notification conditions and the notification contents which are set in advance from the application, is realized, and for example, if the method is realized, the following configuration is provided”.

JP-A-2015-172816 describes that “an object is to provide a numerical control device that can reduce the probability of occurrence of stoppage of processing due to abnormality” and “in the numerical control device, alarm mask information is set in a determination unit in advance, and in accordance with the result of comparing with the alarm cause information generated from each control circuit, masking is performed so as not to send out the alarm to the central processing unit. Accordingly, if it is not necessary to stop the processing according to the type of the alarm cause information, it is possible to lower the probability of occurrence of the stoppage of the processing due to the abnormality” by preventing the alarm from being sent out to the central processing unit.

By collecting various pieces of data (hereinafter, referred to as on-site data) from machines and various sensors at a manufacturing site of a factory, by performing analysis using the collected on-site data, visualization of a site situation, the control of a machine, or the like, introduction of factory IoT which realizes preventive maintenance, productivity improvement, and quality improvement is proceeding. In addition to the posterior analysis performed with respect to the accumulated on-site data, the introduction of edge computing in which the data generated at the site is delivered to an application (hereinafter, referred to as an edge application) to be operated by an edge server, and analyzed or controlled in real time or near real time is also proceeding.

Meanwhile, not only the manufacturing of the product, but also the start-up of the equipment or the trial manufacture is performed at the manufacturing site of the factory. When the posterior analysis is performed using the on-site data collected at the time when the equipment of the factory is in such a state (hereinafter, referred to as abnormal state), or analysis or control by the edge application is performed, inconvenience, such as an output of an abnormal analysis result or performance of incorrect control may occur. Therefore, in a system that performs analysis using the on-site data, or controls the machine, a mechanism for determining whether or not the on-site data is collected in the abnormal state, is required.

In JP-A-2010-244463, if generated data from a data generation device satisfies a notification condition, the application is notified of an event message displaying notification contents. However, an abnormal state cannot be detected if there is no difference in contents of generated data in the normal state and the abnormal state. In addition, in JP-A-2015-172816, the alarm mask information is set in the determination unit in advance, and in accordance with the result of comparing with the alarm cause information generated from each control circuit, masking is performed so as not to send out the alarm to the central processing unit. However, similar to JP-A-2010-244463, the abnormal state cannot be detected if there is no difference in contents of the on-site data that corresponds to the alarm cause information in the normal state and the abnormal state.

### SUMMARY

The invention has been made in consideration of the background, and an object thereof is to provide an abnormal-state detection system and an abnormal-state detection method, capable of detecting whether or not factory equipment is in an abnormal state.

According to an aspect of the invention for achieving the above-described object, there is provided an abnormal-state detection system including: a data receiving unit that receives data sent from factory equipment; a processing execution unit that executes an application which performs information processing based on the received data; a data relation generation unit that generates a data association result which is information indicating the presence of relation between the data; and an abnormal-state determination unit that determines whether or not the factory equipment is in an abnormal state, which is a state other than a normal state which is a state where manufacturing of a product is actually performed, based on the data association result.

In addition, problems to be disclosed by the application and methods of solving the problems will be clarified from the column of the aspect for carrying out the invention and the drawings.

According to the invention, it is possible to detect whether or not the factory equipment is in an abnormal state.

### BRIEF DESCRIPTION OF THE DRAWINGS

FIG. 1 is a diagram illustrating a schematic configuration of an abnormal-state detection system;

FIG. 2 is a block diagram of an information processing apparatus as an example of hardware of an edge server;

FIG. 3 is a diagram illustrating main functions of the edge server and main data managed by the edge server;

FIG. 4 is an example of edge application information;

FIG. 5 is an example of on-site data;

FIG. 6 is an example of system data;

FIG. 7 is an example of data association information;

FIG. 8 is an example of a data association instance;

FIG. 9 is an example of an abnormal-state/control execution determination rule;

FIG. 10 is an example of normal application behavior;

FIG. 11 is an example of an abnormal-state determination result;

FIG. 12 is a sequence diagram describing abnormal-state detection processing;

FIG. 13 is a flowchart describing abnormal-state determination processing (relevant instance use); and

FIG. 14 is a flowchart describing abnormal-state determination processing (application behavior use).

### DETAILED DESCRIPTION OF THE EMBODIMENTS

Hereinafter, embodiments of the invention will be described with reference to the drawings.

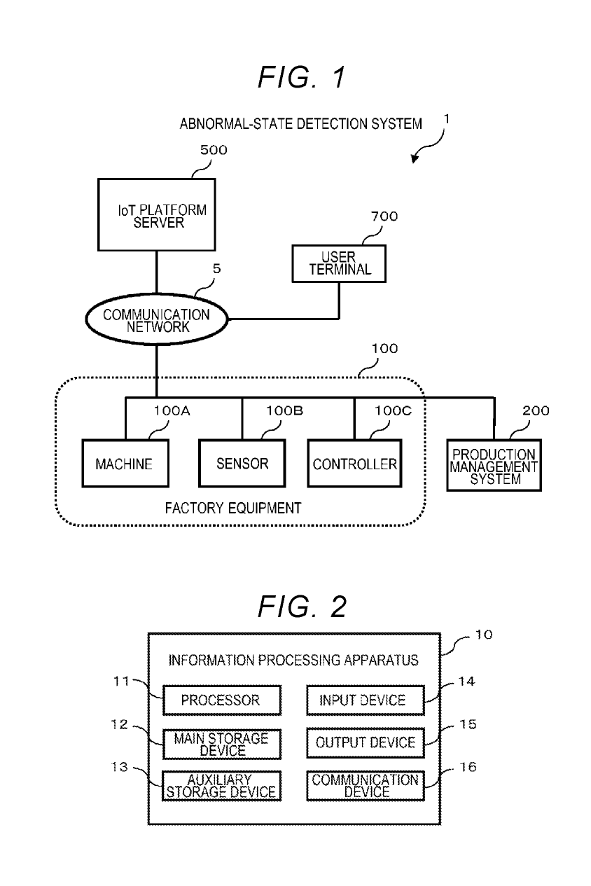

FIG. 1 illustrates a schematic configuration of an abnormal-state detection system 1 described as an embodiment. The abnormal-state detection system 1 includes factory equipment 100, a production management system 200, an IoT board server 500, and a user terminal 700. These are connected to each other to be capable of communicating via a wired or wireless communication network 5, such as a local area network (LAN), a wide area network (WAN) or the like.

The factory equipment 100 includes, for example, a machine 100A, a sensor 100B, and a controller 100C that controls the machine 100A. The machine 100A is, for example, a machine tool, a manufacturing machine, an industrial robot, a molding machine, or the like. For example, the sensor 100B is installed in the machine 100A or in the vicinity of the machine 100A, and measures and outputs information (vibration, pressure, distortion, distance, acceleration, speed, angular acceleration, rotation speed, temperature, humidity, atmospheric pressure, magnetism, or the like) related to the operation of the machine 100A or the surrounding environment of the machine 100A. The controller 100C is, for example, a microcomputer, a factory automation (FA) controller, a programmable logic controller (PLC) controller and the like, and controls or monitors (drive control, sequence control, PLC control, production instruction, quality control, operation history management, output of control information or monitoring information, or the like) of the machine 100A. The factory equipment 100 may further include a device having a function of providing data related to the factory equipment 100, such as a camera (imaging device) which converts the movement of a person into data, or site environment.

The IoT board server 500 acquires information related to operational experience of the machine 100A or manufacturing and processing of the product, and the data (hereinafter, referred to as on-site data), such as a sensor data, from the factory equipment 100 via the communication network 5. In addition, the IoT board server 500 acquires data (hereinafter, referred to as system data), such as execution information of a production plan or a manufacturing plan of the product from the controller 100C or the production management system 200 via the communication network 5. The IoT board server 500 analyzes the acquired on-site data or system data in real time or near real time, and performs the execution control of the application (an application (hereinafter, referred to as edge application) for performing visualization of the manufacturing situation or the like, improvement of efficiency of the manufacturing process, control of the factory equipment 100, preventive maintenance or abnormality sign detection of the factory equipment 100, quality control or the like).

In addition, the IoT board server 500 determines whether or not the on-site data acquired from the factory equipment 100 is data generated in a state (hereinafter, this state is referred to as abnormal state and a state which is not the abnormal state is referred to as normal state) other than a state where the factory equipment 100 manufactures the product, and controls the edge application in accordance with the result of the determination (for example, execution control or notification control which will be described later) or adds information to the on-site data (for example, adding an abnormal-state tag which will be described later). Examples of the abnormal state include a state where the factory equipment 100 is starting up for the introduction thereof, a state where the factory equipment 100 is preliminarily preparing for the start of manufacturing of the product, a state where the factory equipment 100 is performing trial manufacture of the product, and the like.

FIG. 2 is a configuration diagram (block diagram) of an information processing apparatus 10 (computer) as an example of hardware used to realize the IoT board server 500. As illustrated in FIG. 2, the information processing apparatus 10 includes a processor 11, a main storage device 12, an auxiliary storage device 13, an input device 14, an output device 15, and a communication device 16. These are connected to each other to be capable of communicating via communication means, such as a bus (not illustrated). Furthermore, the information processing apparatus 10 does not necessarily have to be realized by hardware, and for example, a part or the entirety of the configuration may be realized by a virtual resource, such as a cloud server of a cloud system. The user terminal 700 or the production management system 200 can also be realized by using the information processing apparatus 10.

The processor 11 is configured using, for example, a central processing unit (CPU), a micro processing unit (MPU), or the like. Various functions of the IoT board server 500 are realized as the processor 11 reads and executes the program stored in the main storage device 12.

The main storage device 12 is a device that stores programs or data, and is, for example, a read only memory (ROM), a random access memory (RAM), a nonvolatile RAM (NVRAM), or the like.

The auxiliary storage device 13 is, for example, a reading and writing device of a storage medium, such as a solid state drive (SSD), a hard disk drive, an optical storage device (compact disc (CD) and digital versatile disc (DVD)) and the like), a storage system, an IC card, an SD memory card, a flexible disk (FD) or the like; a storage region of a cloud server, and the like. Programs or data stored in the auxiliary storage device 13 are read into the main storage device 12 as needed. The data managed by the IoT board server 500 is managed by, for example, a data base management system (DBMS) or a key value store (KVS) that use the auxiliary storage device 13 as a data storage region.

The input device 14 is an interface (or a user interface) for inputting information, and is, for example, a keyboard, a mouse, a touch panel, a card reader, a microphone, or the like.

The output device 15 is an interface (or a user interface) for outputting various types of information, such as a screen display device (a liquid crystal monitor, a liquid crystal display (LCD), a graphic card and the like) or a printing device.

The communication device 16 is a wired or wireless communication interface that realizes communication with another device via the communication means, such as a LAN or the internet, and is, for example, a network interface card (NIC) or various wireless communication modules.

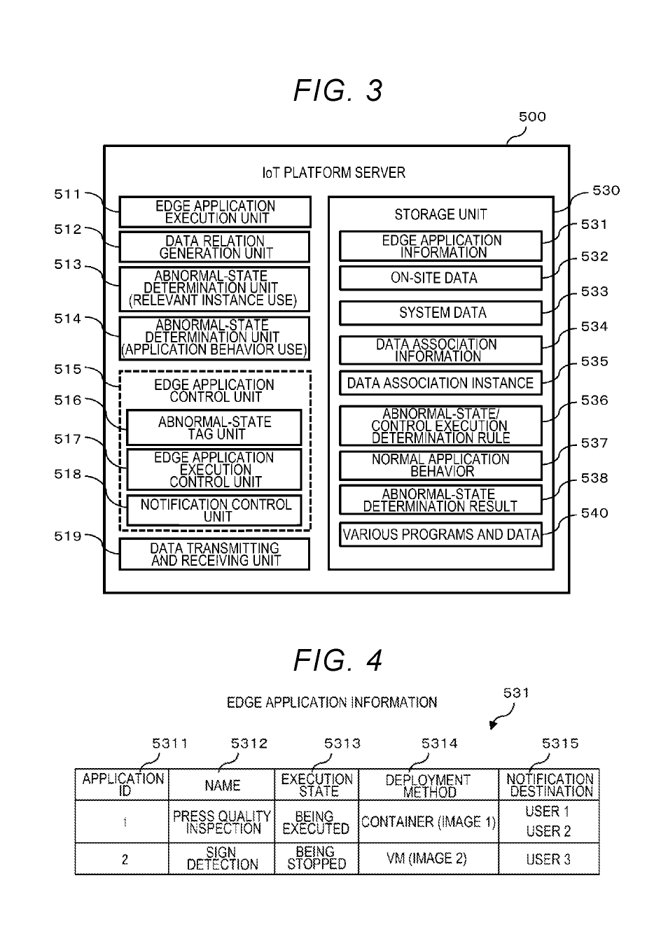

FIG. 3 illustrates main functions of the IoT board server 500 and main data managed by the IoT board server 500. As illustrated in FIG. 3, the IoT board server 500 includes each function of an edge application execution unit 511, a data relation generation unit 512, an abnormal-state determination unit (relevant instance use) 513, an abnormal-state determination unit (application behavior use) 514, an edge application control unit 515, an abnormal-state tag unit 516, an edge application execution control unit 517, a notification control unit 518, a data transmission and reception unit 519, and a storage unit 530. Each of the above-described functions is realized as the processor 11 reads and executes a program (including a program read from the auxiliary storage device 13 to the main storage device 12) for realizing each of the above-described functions stored in the main storage device 12.

As illustrated in FIG. 3, the storage unit 530 manages (stores) edge application information 531, on-site data 532, system data 533, data association information 534, a data association instance 535, an abnormal-state/control execution determination rule 536, a normal application behavior 537, an abnormal-state determination result 538, and various programs and data 540.

The on-site data 532 is the above-described on-site data received from the factory equipment 100 (the machine 100A, the sensor 100B, and the controller 100C). The system data 533 is the above-described system data received from the production management system 200 or the controller 100C. The various programs and data 540 includes programs or data for realizing each of the above-described functions or the edge application. The details of the edge application information 531, the data association information 534, the data association instance 535, the abnormal-state/control execution determination rule 536, the normal application behavior 537, and the abnormal-state determination result 538 will be described later.

The edge application execution unit 511 realizes the function of the edge application. The edge application has functions related to, for example, visualization of the manufacturing situation and the like, improvement of efficiency of the manufacturing process, control of the factory equipment 100, preventive maintenance or abnormality sign detection of the factory equipment 100, quality control of the product (for example, quality inspection or the like of the press working), and the like.

The data relation generation unit 512 generates the data association instance 535 which is information related to the relation of the on-site data or the system data, based on the data association information 534.

The abnormal-state determination unit (relevant instance use) 513 determines whether or not the on-site data acquired from the factory equipment 100 is the data generated when the factory equipment 100 is in the abnormal state, based on the data association instance 535 and the abnormal-state/control execution determination rule 536, and generates the abnormal-state determination result 538 which is information including the determination result.

The abnormal-state determination unit (application behavior use) 514 determines whether or not the on-site data acquired from the factory equipment 100 is the data generated when the factory equipment 100 is in the abnormal state, based on the information (hereinafter, also referred to as behavior information) related to the behavior of the edge application, and generates the abnormal-state determination result 538 which is information including the determination result.

The edge application control unit 515 controls the edge application in accordance with the determination results of the abnormal-state determination unit (relevant instance use) 513 or the abnormal-state determination unit (application behavior use) 514. As illustrated in FIG. 3, the edge application control unit 515 includes each of the functions of the abnormal-state tag unit 516, the edge application execution control unit 517, and the notification control unit 518. Among these, the abnormal-state tag unit 516 adds the abnormal-state tag which will be described later to the on-site data in accordance with the determination result. The edge application execution control unit 517 performs an execution prevention control of the edge application in accordance with the determination result. In accordance with the determination result, the notification control unit 518 performs the prevention control of transmission of a notification (message) from the edge application to the user terminal 700.

The data transmission and reception unit 519 receives the data, such as the on-site data or the system data sent from the factory equipment 100 or the production management system 200 via the communication network 5. In addition, the data transmission and reception unit 519 communicates with other devices, such as the user terminal 700, via the communication network 5 and transmits and receives various pieces of data. The entirety or a part of the data transmission and reception unit 519 may be realized by using, for example, a message broker, a message hub, or the like.

FIG. 4 is an example of the edge application information 531. In the edge application information 531, information related to the edge application is managed. As illustrated in FIG. 4, the edge application information 531 includes one or more records having each item of an application ID 5311, a name 5312, an execution state 5313, a deployment method 5314, and a notification destination 5315. One record of the edge application information 531 corresponds to one edge application.

In the application ID 5311, an identifier of the edge application (hereinafter, referred to as application ID) is set. In the name 5312, information indicating the name of the edge application is set. In the execution state 5313, information indicating the execution state of the edge application (“being executed” or “being stopped”) is set. In the deployment method 5314, information indicating a method (hereinafter, referred to as a deployment method) of deploying the edge application is set. Furthermore, the contents of the deployment method 5314 are used when the abnormal-state determination unit (application behavior use) 514 runs the edge application when acquiring the behavior information of the edge application. In the notification destination 5315, the information indicating one or more notification destinations of the information from the edge application is set.

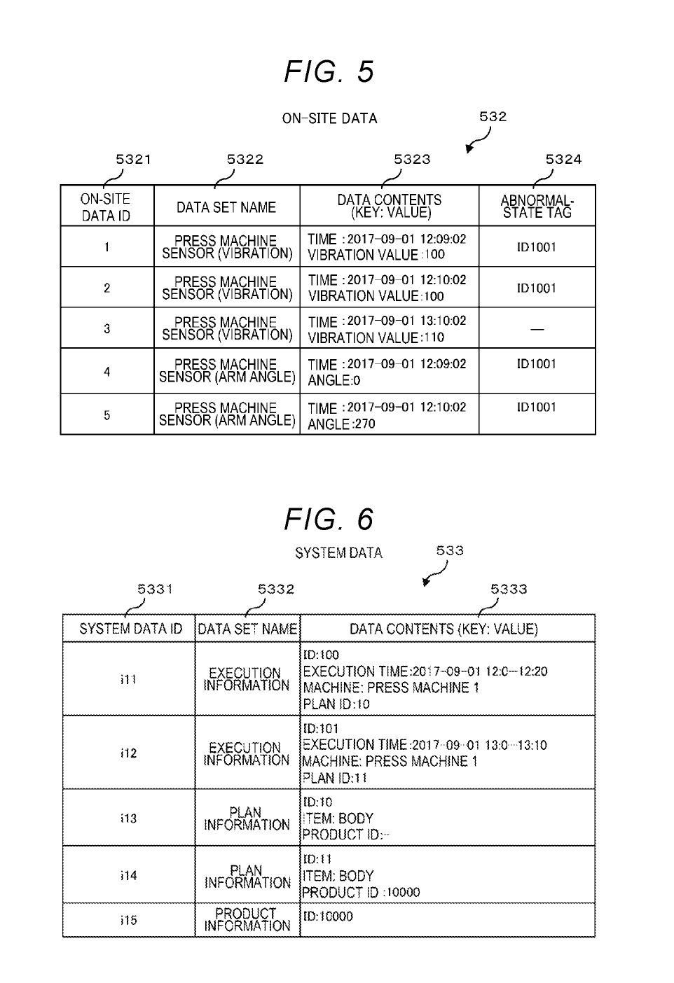

FIG. 5 illustrates an example of the on-site data 532. As illustrated in FIG. 5, the on-site data 532 includes one or more records having each item of an on-site data ID 5321, a data set name 5322, data contents 5323, and abnormal-state tag 5324. One record of the on-site data 532 corresponds to one piece of the on-site data.

In the on-site data ID 5321, an identifier of the on-site data (hereinafter, referred to as the on-site data ID) is set. In the data set name 5322, the information (including information that can specify the type of the data set) indicating the name of the data set is set. In the example, two types of data sets are exemplified with “press machine sensor (vibration)” and “press machine sensor (arm angle)”.

In the data contents 5323, the entity (contents) of the on-site data is set. As illustrated in FIG. 5, the on-site data includes one or more sets of keys and values. For example, in the data contents 5323 of the record having the on-site data ID with “1”, a value of “2017-09-01 12:09:02” is set for the key “time”.

In the abnormal-state tag 5324, if the abnormal-state determination unit (relevant instance use) 513 or the abnormal-state determination unit (application behavior use) 514 determines that the on-site data is in the abnormal state, the contents of the information (hereinafter, referred to as abnormal-state tag) given to the on-site data are set.

FIG. 6 illustrates an example of the system data 533. As illustrated in FIG. 6, the system data 533 includes one or more records having each item of a system data ID 5331, a data set name 5332, and data contents 5333. One record of the system data 533 corresponds to one piece of the system data.

In the system data ID 5331, an identifier of the system data (hereinafter, referred to as the system data ID) is set. In the data set name 5332, the information (including information that can specify the type of the data set) indicating the name of the data set (hereinafter, referred to as data set name) is set. In the example, illustrated is an example in which, in the data set name 5332, “execution information” indicating that the data set is information related to the execution (hereinafter, referred to as execution information) of the factory equipment 100, “plan information” indicating that the data set is information related to the execution plan (hereinafter, referred to as plan information) of the factory equipment 100, and “product information” indicating that the data set is information related to the product manufactured by the factory equipment 100 are set. In the data contents 5333, the entity (contents) of the system data is set. As illustrated in FIG. 6, the system data includes one or more sets of keys and values.

In the case of the example, in the system data having the system data ID with “i11”, “execution information” is set in the data set name 5332, and “ID: 100, Execution time: 2017-09-01 12:0-12:20, Machine: press machine 1, Plan ID: 10” is set in the data contents 5333. Here, “ID: 100” indicates that an identifier given to the execution information (hereinafter, referred to as execution ID) is “100”. In addition, “Execution time: 2017-09-01 12:0-12:20, Machine: press machine 1, Plan ID: 10” indicates that the press machine specified as “press machine 1” is operated during “2017-09-01 12:0-12:20” in accordance with the plan information of which the plan ID which will be described later is “10”.

In addition, in the system data having the system data ID with “i12”, “execution information” is set in the data set name 5332, and “ID: 101, Execution time: 2017-09-01 13:0-13:10, Machine: press machine 1, Plan ID: 11” is set in the data contents 5333. Here, “ID: 101” indicates that the execution ID is “101”. In addition, “Execution time: 2017-09-01 13:0-13:10, Machine: press machine 1, Plan ID: 11” indicates that the press machine specified as “press machine 1” is operated during “2017-09-01 13:0-13:10” in accordance with the plan information of which the plan ID which will be described later is “11”.

In addition, in the system data having the system data ID with “i13”, “plan information” is set in the data set name 5332, and “ID: 10, Item: body, Product ID: -” is set in the data contents 5333. Here, “ID: 10” indicates that an identifier given to the plan information (hereinafter, referred to as plan ID) is “10”. In addition, “Item: body, Product ID: -” indicates that the item manufactured in accordance with the plan information is “body” and the identifier of the product (hereinafter, referred to as product ID) manufactured in accordance with the plan information is not set.

In addition, in the system data having the system data ID with “i14”, “plan information” is set in the data set name 5332, and “ID: 11, Item: body, Product ID: 10000” is set in the data contents 5333. Here, “ID: 11” indicates that the plan ID is “11”. In addition, “Item: body, Product ID: 10000” indicates that the item manufactured in accordance with the plan information is “body” and the product ID of the item manufactured in accordance with the plan information is “10000”.

In addition, in the record having the system data ID with “i15”, “product information” is set in the data set name 5332, and “ID: 10000” is set in the data contents 5333. Here, “ID: 10000” indicates that “10000” is given as a product ID of a certain product.

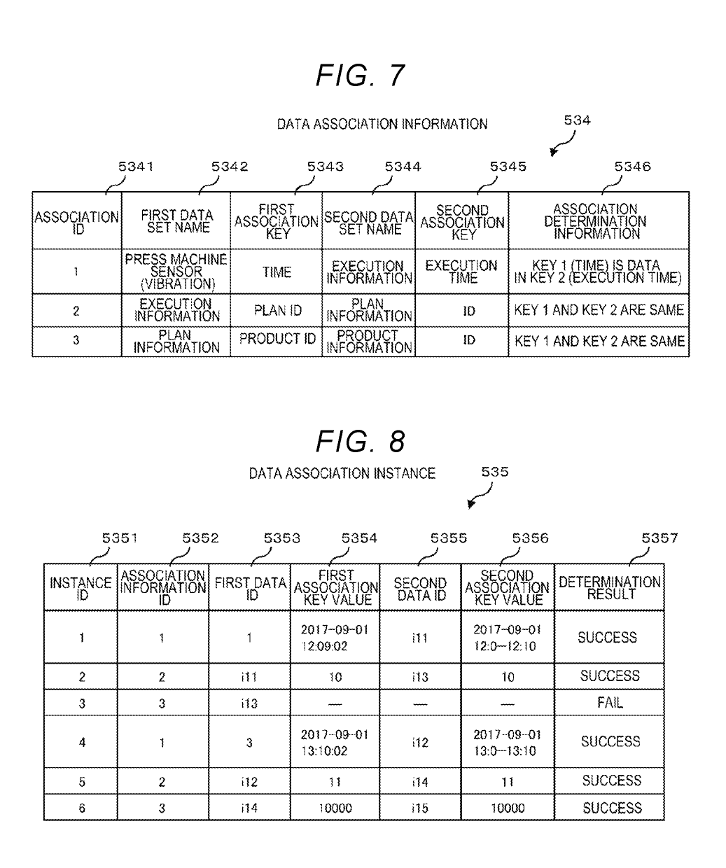

FIG. 7 illustrates an example of the data association information 534. The data association information 534 manages the information indicating how to associate data sets with each other (hereinafter, referred to as association information).

As illustrated in FIG. 7, the data association information 534 includes one or more records having each item of an association ID 5341, a first data set name 5342, a first association key 5343, a second data set name 5344, a second association key 5345, and association determination information 5346. One record of the data association information 534 corresponds to one piece of the association information.

In the association ID 5341, an identifier of the association information (hereinafter, referred to as association ID) is set.

In the first data set name 5342, the data set name of one associated data set (hereinafter, also referred to as first data set) is set. In the first association key 5343, information (hereinafter, referred to as first association use information) for specifying information to be used for association among the information included in one of the associated data sets is set. In the second data set name 5344, the data set name of another one of the associated data sets (hereinafter, also referred to as second data set) is set. In the second association key 5345, information (hereinafter, referred to as second association use information) for specifying information to be used for association among the information included in another one of associated data sets is set. In the association determination information 5346, information to be used for determining whether or not the first data set and the second data set can be associated with each other (hereinafter, referred to as association determination information) is set.

FIG. 8 illustrates an example of the data association instance 535. The data association instance 535 manages information indicating the result of the association based on the data association information 534 (hereinafter, referred to as an instance). As illustrated in FIG. 8, the data association instance 535 includes one or more records having each item of an instance ID 5351, an association ID 5352, a first data ID 5353, a first association key value 5354, a second data ID 5355, a second association key value 5356, and a determination result 5357. One record of the data association instance 535 corresponds to one instance.

In the instance ID 5351, an identifier of the instance (hereinafter, referred to as an instance ID) is set. In the association ID 5352, an association ID of the association information used for associating the instance is set. In the first data ID 5353, information (for example, the on-site data ID or the system data ID, and hereinafter, referred to as first data ID) for specifying the first data set which is one data set that is an association target is set. In the first association key value 5354, the value of the information specified by the above-described first association use information is set. In the second data ID 5355, information (for example, the on-site data ID or the system data ID, and hereinafter, referred to as second data ID) for specifying the second data set which is another data set that is an association target is set. In the second association key value 5356, the value of the information specified by the second association use information is set. In the determination result 5357, information indicating whether or not the first data set and the second data set can be associated with each other is set (“success” is set if the association is possible, and “fail” is set if the association is not possible).

In FIG. 8, the instance having the instance ID with “1” is a result of associating the data set having the on-site data ID of the on-site data 532 of FIG. 5 with “1” and the data set having the system data ID of the system data 533 of FIG. 6 with “i11” by the association information having the association ID of the data association information 534 of FIG. 7 with “1”, and is set to “success” in the determination result 5357.

In FIG. 8, the instance having the instance ID with “2” is a result of associating the data set having the system data ID of the system data 533 of FIG. 6 with “i11” and the data set having the system data ID of the system data 533 of FIG. 6 with “i13” by the association information having the association ID of the data association information 534 of FIG. 7 with “2”, and is set to “success” in the determination result 5357.

In FIG. 8, the instance having the instance ID with “3” is a result of trying the association with respect to the data set having the system data ID of the system data 533 of FIG. 6 with “i13” by the association information having the association ID of the data association information 534 of FIG. 7 with “3”, and is set to “fail” in the determination result 5357.

In FIG. 8, the instance having the instance ID with “4” is a result of associating the data set having the on-site data ID of the on-site data 532 of FIG. 5 with “3” and the data set having the system data ID of the system data 533 of FIG. 6 with “i12” by the association information having the association ID of the data association information 534 of FIG. 7 with “1”, and is set to “success” in the determination result 5357.

In FIG. 8, the instance having the instance ID with “5” is a result of associating the data set having the system data ID of the system data 533 of FIG. 6 with “i12” and the data set having the system data ID of the system data 533 of FIG. 6 with “i14” by the association information having the association ID of the data association information 534 of FIG. 7 with “2”, and is set to “success” in the determination result 5357.

In FIG. 8, the instance having the instance ID with “6” is a result of associating the data set having the system data ID of the system data 533 of FIG. 6 with “i14” and the data set having the system data ID of the system data 533 of FIG. 6 with “i15” with each other by the association information having the association ID of the data association information 534 of FIG. 7 with “3”, and is set to “success” in the determination result 5357.

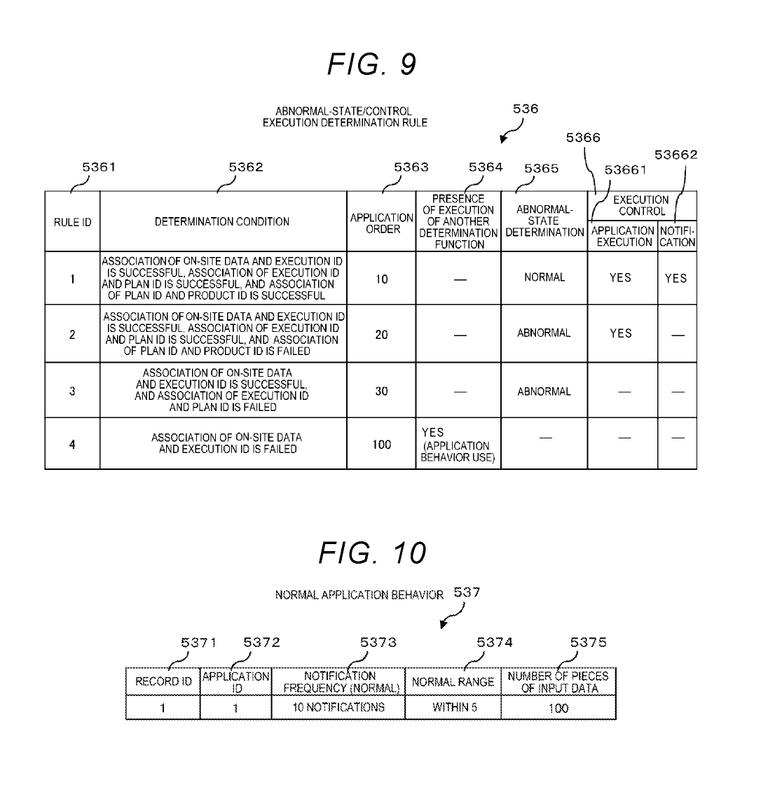

FIG. 9 illustrates an example of the abnormal-state/control execution determination rule 536. The abnormal-state/control execution determination rule 536 manages the information (hereinafter, referred to as determination rule) including the conditions used for determining whether or not the on-site data is the data in the abnormal state based on the data association instance 535 and the information indicating whether or not the control (execution control or notification prevention control with respect to the user terminal 700) of the edge application.

As illustrated in FIG. 9, the abnormal-state/control execution determination rule 536 includes one or more records having each item of a rule ID 5361, a determination condition 5362, an application order 5363, presence of execution of another determination function 5364, an abnormal-state determination 5365, and an execution control 5366 (application execution 53661 and notification 53662). One record of the abnormal-state/control execution determination rule 536 corresponds to one determination rule.

In the rule ID 5361, an identifier of the determination rule (hereinafter, referred to as rule ID) is set. In the determination condition 5362, the contents of the determination rule is set. In the application order 5363, information indicating the application order of the determination rule is set. In the example, the determination rule having a smaller value set in the application order 5363 is applied to the data association instance 535 in order.

In the presence of execution of another determination function 5364, the information indicating whether or not another determination function (abnormal-state determination unit (application behavior use) 514 in the embodiment) is executed if the abnormal-state determination unit (relevant instance use) 513 cannot perform the determination, and the information for specifying the above-described another determination function, are set.

In the abnormal-state determination 5365, information indicating the determination result is set if the data association instance 535 satisfies the determination condition 5362 (“normal” is set if the normal state is determined and “abnormal” is set if the abnormal state is determined).

In the execution control 5366, information related to the execution control of the edge application is set. In the application execution 53661, information indicating whether or not the execution prevention control of the edge application is performed if the data association instance 535 satisfies the determination condition 5362 is set (“-” is set if the execution prevention control is performed and “YES” is set if the execution prevention control is not performed). In the notification 53662, information indicating whether or not a transmission prevention control of the notification (message) from the edge application to the user terminal 700 is performed if the data association instance 535 satisfies the determination condition 5362 is set (“-” is set if the transmission prevention control is performed and “YES” is set if the transmission prevention control is not performed).

FIG. 10 illustrates an example of the normal application behavior 537. The normal application behavior 537 includes information used when the abnormal-state determination unit (application behavior use) 514 determines whether or not the on-site data is in the abnormal state. As illustrated in FIG. 10, the normal application behavior 537 includes one or more records having each item of a record ID 5371, an application ID 5372, a notification frequency (normal) 5373, a normal range 5374, and a number of pieces of input data 5375.

In the record ID 5371, an identifier of the record is set. In the application ID 5372, the application ID of the edge application to which the information of the record is applied is set. In the notification frequency (normal) 5373, the information indicating the frequency of the notification (hereinafter, referred to as notification frequency) performed with respect to the user terminal 700 from the edge application when the factory equipment 100 is in the normal state and the on-site data of which the number is set in the number of pieces of input data 5375 is input into the edge application is set. In the normal range 5374, information indicating the range (within ±5 in the example) of the notification frequency from the value set in the notification frequency (normal) 5373 if the factory equipment 100 is determined to be in the normal state is set. In the number of pieces of input data 5375, the number of pieces of on-site data to be input into the edge application when running the edge application when acquiring the behavior information is set.

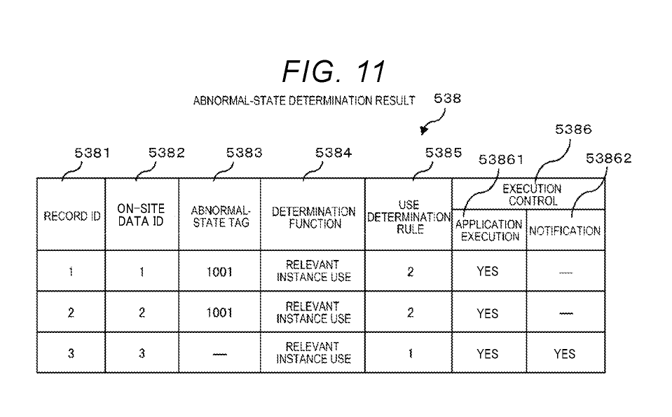

FIG. 11 illustrates an example of the abnormal-state determination result 538. The abnormal-state determination result 538 includes information related to the determination result regarding whether or not the factory equipment 100 is in the abnormal state by the abnormal-state determination unit (relevant instance use) 513 or the abnormal-state determination unit (application behavior use) 514. As illustrated in FIG. 11, the abnormal-state determination result 538 includes one or more records having each item of a record ID 5381, an on-site data ID 5382, an abnormal-state tag 5383, a determination function 5384, a use determination rule 5385, and an execution control 5386 (application execution 53861 and notification 53862). One record of the abnormal-state determination result 538 corresponds to one piece of the on-site data.

In the record ID 5381, identifiers of each record are set. In the on-site data ID 5382, the on-site data ID of the on-site data which is the determination target is set. In the abnormal-state tag 5383, the value of the abnormal-state tag given to the on-site data is set if the factory equipment 100 is determined to be in the abnormal state. In the determination function 5384, information indicating the function used for determining the on-site data of the record is set (“relevant instance use” is set if the abnormal-state determination unit (relevant instance use) 513 is used for the determination and “application behavior use” is set if the abnormal-state determination unit (application behavior use) 514 is used for determination). In the use determination rule 5385, the determination rule ID of the determination rule used for the determination if “relevant instance use” is set to the determination function 5384 is set. In the execution control 5386, the contents of the execution control performed with respect to the edge application is set. “-” is set in the application execution 53861 if the execution control of the edge application is performed, and “-” is set in the notification 53861 if the prevention control of the transmission of the notification (message) from the edge application to the user terminal 700.

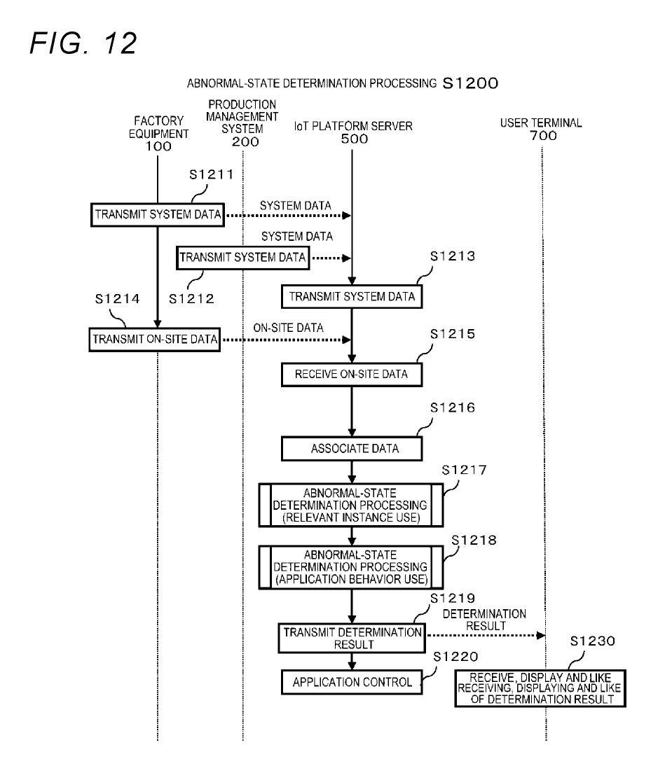

FIG. 12 is a sequence diagram for describing a flow of processing performed in the abnormal-state detection system 1 (hereinafter, referred to as abnormal-state detection processing S1200). Hereinafter, the abnormal-state detection processing S1200 will be described with reference to FIG. 12.

As illustrated in FIG. 12, the data transmission and reception unit 519 of the IoT board server 500 receives the system data sent from the production management system 200 and the factory equipment 100 (S1211 to S1213). The storage unit 530 stores the system data received by the data transmission and reception unit 519 as the system data 533. In addition, the data transmission and reception unit 519 receives the on-site data sent from the factory equipment 100 (S1214 to S1215). The storage unit 530 stores the on-site data received by the data transmission and reception unit 519 as the on-site data 532.

Furthermore, in the embodiment, a case where the IoT board server 500 processes the system data or the on-site data sent from the production management system 200 or the factory equipment 100 in real time or near real time is assumed, but the system data or the on-site data which has been accumulated and stored during a predetermined period may be processed posteriorly by batch processing or the like.

Next, the data relation generation unit 512 of the IoT board server 500 associates the data set of the on-site data 532 and the data set of the system data 533 based on the data association information 534, and the storage unit 530 stores the association result as the data association instance 535 (S1216).

Subsequently, the abnormal-state determination unit (relevant instance use) 513 of the IoT board server 500 performs processing of determining whether or not the data is in the abnormal state (hereinafter, referred to as abnormal-state determination processing (relevant instance use) S1217) by using the data association instance 535. The details of the abnormal-state determination processing (relevant instance use) S1217 will be described later.

In S1218, the abnormal-state determination unit (application behavior use) 514 of the IoT board server 500 executes determination processing (hereinafter, referred to as abnormal-state determination processing (application behavior use) S1218) specified by another determination function name included in the above-described result of the abnormal-state determination processing (relevant instance use) S1217.

In S1219, the data transmission and reception unit 519 transmits the result of the abnormal-state determination processing (relevant instance use) S1217 or the result of the abnormal-state determination processing (application behavior use) S1218 to the user terminal 700 via the communication network 5. The user terminal 700 receives the result of the abnormal-state determination processing (relevant instance use) S1217 or the result of abnormal-state determination processing (application behavior use) S1218, which have been received from the IoT board server 500, and displays the received contents or executes processing that corresponds to the received contents (S1230).

In S1220, the edge application control unit 515 of the IoT board server 500 performs the execution control of the edge application in accordance with the contents of the execution control 5386 of the abnormal-state determination result 538. For example, the edge application control unit 515 prevents the execution of the edge application if “-” is set in the application execution 53861 of the abnormal-state determination result 538. In addition, if “-” is set in the notification 53862 of the abnormal-state determination result 538, the transmission of the notification (message) from the edge application to the user terminal 700 is prevented. The edge application control unit 515 executes the edge application performed by inputting the on-site data having the value set in the abnormal-state tag 5383 of abnormal-state determination result 538, or prevents the transmission of the notification (message) from the edge application to the user terminal 700. Accordingly, it is possible to prevent unnecessary execution of the edge application when the factory equipment 100 is in the abnormal state or unnecessary notification from the edge application to the user.

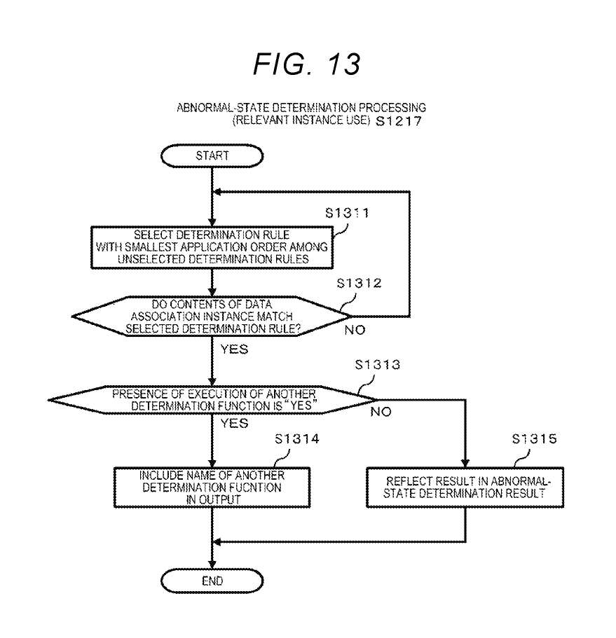

FIG. 13 is a flowchart describing the details of the abnormal-state determination processing (relevant instance use) S1217 of FIG. 12. Hereinafter, the abnormal-state determination processing (relevant instance use) S1217 will also be described with reference to FIG. 13.

First, the abnormal-state determination unit (relevant instance use) 513 selects a determination rule having the smallest value of the application order 5363 among the determination rules not selected in the step defined in the abnormal-state/control execution determination rule 536 (S1311).

Next, the abnormal-state determination unit (relevant instance use) 513 compares the selected determination rule and the contents of the data association instance 535 to determine whether or not the data association instance 535 matches the selected determination rule (S1312). If the data association instance 535 does not match the selected determination rule (S1312: NO), the processing returns to S1311. Then, the next determination rule is selected and the determination of S1312 is performed. If the data association instance 535 matches the selected determination rule (S1312: YES), the processing proceeds to S1313.

In S1313, the abnormal-state determination unit (relevant instance use) 513 determines whether or not “YES” is set in the presence of execution of another determination function 5364 of the abnormal-state/control execution determination rule 536 (in the example, the data association instance 535 matches the determination rule of “4” for the rule ID 5361 of FIG. 9). If “YES” is set in the presence of execution of another determination function 5364 (S1313: YES), the abnormal-state determination unit (relevant instance use) 513 includes information (name of another determination function, or the like) for specifying another determination function set in the presence of execution of another determination function 5364 in the output of the abnormal-state determination processing (relevant instance use) S1217. Furthermore, the abnormal-state determination unit (relevant instance use) 513 inputs the above-described output of the abnormal-state determination processing (relevant instance use) S1217 into the abnormal-state determination processing (application behavior use) S1218 in FIG. 12.

Meanwhile, if “YES” is not set in the presence of execution of another determination function 5364 (S1313: NO), the abnormal-state determination unit (relevant instance use) 513 reflects (adds the record) the determination result in the abnormal-state determination result 538 (S1315). In addition, if the factory equipment 100 is determined to be in the abnormal state, the abnormal-state determination unit (relevant instance use) 513 issues an abnormal-state tag and sets the issued abnormal-state tag to the abnormal-state tag 5383 of the added record. Furthermore, if the on-site data sent from the same factory equipment 100 is determined to be in the abnormal state by the same determination rule, for example, the abnormal-state tag having the same value is set in the abnormal-state tag 5383 of the record of the same on-site data. As described above, the abnormal-state tag set in this manner is appropriately referred to by, for example, the edge application control unit 515, and the edge application control unit 515 considers the processing of the edge application inputting the on-site data where the abnormal-state tag is set as the target of the execution prevention.

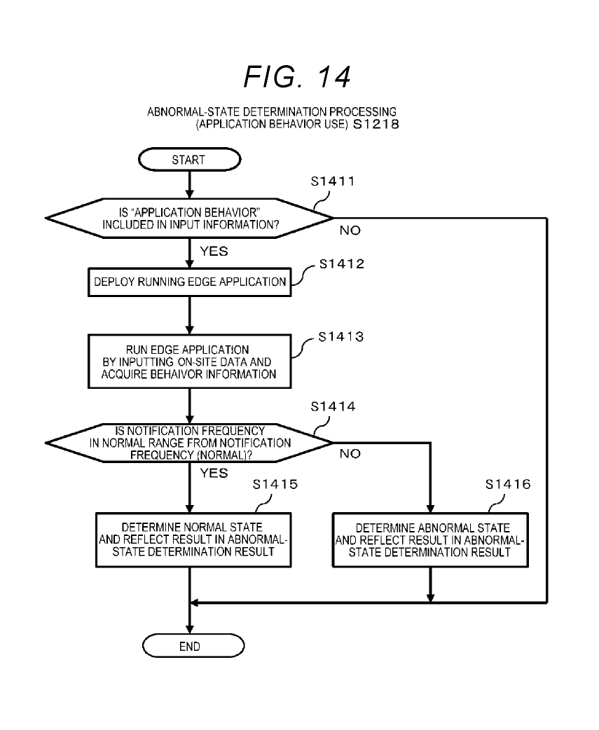

FIG. 14 is a flowchart describing the details of the abnormal-state determination processing (application behavior use) S1218 of FIG. 12. Hereinafter, the abnormal-state determination processing (application behavior use) S1218 will be described with reference to FIG. 14.

First, the abnormal-state determination unit (application behavior use) 514 determines whether or not the information (name of another determination function) for specifying another determination function is included in the output of the input abnormal-state determination processing (relevant instance use) S1217. In the example, it is determined whether or not “application behavior” is included as the name of another determination function (S1411). If “application behavior” is included in the input information (the above-described output) (S1411: YES), the processing proceeds to S1412. Meanwhile, if “application behavior” is not included in the input information (S1411: NO), the abnormal-state determination processing (application behavior use) S1218 ends. Furthermore, in the example, the processing ends if “application behavior” is not included as the name of another determination function in the information input in this manner, but one or more other determination functions may be further prepared to perform the determination with another determination function that corresponds to the information for specifying another determination function of the output that is input as described above.

In S1412, in order to acquire the behavior information of the edge application, the abnormal-state determination unit (application behavior use) 514 deploys the edge application specified by the application ID set in the application ID 5372 of the normal application behavior 537 with respect to the edge application by a deployment method set in the deployment method 5314 of the edge application information 531.

Next, the abnormal-state determination unit (application behavior use) 514 runs (executes) the deployed edge application to input the on-site data, and acquires the result (behavior information) (S1413). For example, the abnormal-state determination unit (application behavior use) 514 acquires the frequency of notification (message) from the edge application to the user terminal 700 as the behavior information. In the edge application to be run, for example, the on-site data having the number of values set in the number of pieces of input data 5375 of the normal application behavior 537 is input.

Subsequently, the abnormal-state determination unit (application behavior use) 514 determines whether or not the acquired notification frequency is within a range specified by the notification frequency (normal) 5373 and the normal range 5374 (S1414). If the acquired notification frequency is within the range specified by the notification frequency (normal) 5373 and the normal range 5374 (S1414: YES), the abnormal-state determination unit (application behavior use) 514 determines that the factory equipment 100 is in the normal state, and reflects (adds the record) the determination result to the abnormal-state determination result 538 (S1415). Meanwhile, if the acquired notification frequency is not within the range specified by the notification frequency (normal) 5373 and the normal range 5374 (S1414: NO), the abnormal-state determination unit (application behavior use) 514 determines that the factory equipment 100 is in the abnormal state, and reflects (adds the record) the determination result to abnormal-state determination result 538 (S1416).

In this manner, even if the abnormal-state determination unit (relevant instance use) 513 cannot determine whether or not the factory equipment 100 is in the abnormal state, it is possible to determine whether or not the factory equipment 100 is in the abnormal state by the determination processing caused by another determination function.

As described in detail above, according to the abnormal-state detection system 1 of the embodiment, it is possible to determine whether or not the factory equipment 100 is in the abnormal state based on the on-site data sent from the factory equipment 100. In addition, the execution control of the edge application can be performed based on the determination result. Further, since it is determined whether or not the factory equipment 100 is in the abnormal state based on the relation of the on-site data or the system data rather than the contents of the on-site data, it is possible to determine whether or not the factory equipment is in the abnormal state, for example, even if there is no difference in contents of the on-site data.

Although the invention has been specifically described based on the embodiments above, the invention is not limited to the above-described embodiments, and various changes can be made without departing from the gist of the invention. For example, the above-described embodiments have been described in detail in order to describe the invention in an easy-to-understand manner, and are not necessarily limited to those having all of the described configurations. Further, with respect to a part of the configuration of the above-described embodiments, other configurations can be added, deleted, or replaced.

In addition, each of the above-described configurations, functional units, processing units, processing means, and the like may be realized by hardware, by designing a part or the entirety of these, for example, on an integrated circuit or the like. Further, each of the above-described configurations, functions, and the like may be realized by software by interpreting and executing a program realizing each function with the processor. Information, such as programs, tables, files, and the like that realize each function can be stored in a recording device, such as a memory, a hard disk or a solid state drive (SSD), or a recording medium, such as an IC card, an SD card, or a DVD.

In addition, the control lines or the information lines in each of the drawings are what are considered to be necessary for the description, and all the control lines or information lines on the mounting are not necessarily illustrated. For example, it may be considered that almost all the configurations are actually connected to each other.

In addition, the arrangement aspect of various functional units, various processing units, and various databases of the information processing apparatus described above is merely an example. Regarding the arrangement aspect of various functional units, various processing units, and various databases, each information processing apparatus can be changed to the optimal arrangement aspect in view of hardware or software performance, processing efficiency, communication efficiency and the like.

Although the present disclosure has been described with reference to example embodiments, those skilled in the art will recognize that various changes and modifications may be made in form and detail without departing from the spirit and scope of the claimed subject matter.

What is claimed is:

1. An abnormal-state detection system comprising:
a data receiving unit that receives data sent from factory equipment;
a processing execution unit that executes an application which performs information processing based on the received data;
a data relation generation unit that generates a data association result which is information indicating the presence of relation between the data; and
an abnormal-state determination unit that determines whether or not the factory equipment is in an abnormal state, which is a state other than a normal state which is a state where manufacturing of a product is actually performed, based on the data association result.

2. The abnormal-state detection system according to claim 1, further comprising:
a control unit that performs a control for preventing an influence of the application on the information processing based on a result of the determination.

3. The abnormal-state detection system according to claim 2, wherein
the abnormal-state detection system is connected to a user terminal so as to be capable of communicating therewith,
the information processing includes processing of transmitting a notification to the user terminal, and
the prevention control is a control for preventing the transmission of the notification.

4. The abnormal-state detection system according to claim 2, further comprising:
a tag unit for tagging the received data if the factory equipment is determined to be in the abnormal state, and
the control unit performs the prevention control on the tagged data as a target.

5. The abnormal-state detection system according to claim 1, wherein
information indicating a behavior of the information processing is stored in the normal state, and
the abnormal-state determination unit determines whether or not the factory equipment is in the abnormal state by comparing information acquired by running the information processing while inputting the received data and information indicating the behavior in the normal state if it is not possible to determine whether or not the factory equipment is in the abnormal state based on the data association result.

6. The abnormal-state detection system according to claim 1, further comprising:
a storage unit that stores data association information which is information that serves as a determination rule for determining the presence of relation between the data, and
the data relation generation unit generates the data association result by determining the presence of relation between the data based on the data association information.

7. The abnormal-state detection system according to claim 6, wherein
the data association information includes information indicating a relationship between a value of a key included in one of the data which is a determination target of relation and a value of a key included in the other one of the data which is a determination target of relation.

8. The abnormal-state detection system according to claim 1, wherein
the data includes on-site data which is data acquired by a sensor which monitors the factory equipment and system data which is data including at least one of plan information when executing the factory equipment, execution information, and information that specifies a product to be manufactured, and
the data association result includes at least one of the presence of relation between the on-site data and the plan information, the presence of relation between the plan information and the execution information, and the presence of relation between the plan information and the information for specifying the product.

9. The abnormal-state detection system according to claim 1, wherein
the information processing is processing related to at least one of analysis of the received data, visualization of a manufacturing situation of the factory equipment, improvement of efficiency of a manufacturing process of the factory equipment, control of the factory equipment, preventive maintenance of the factory equipment, abnormality sign detection of the factory equipment, and the quality management of the product to be manufactured by the factory equipment.

10. The abnormal-state detection system according to claim 1, wherein
the abnormal state is a state which is any one of a state where the factory equipment is starting up for introduction, a state where the factory equipment is preliminarily preparing for starting manufacturing of the product, and a state where the factory equipment is performing trial manufacturing of the product.

11. An abnormal-state detection method implemented by an information processing apparatus, comprising:
receiving data sent from factory equipment;
executing an application which performs information processing based on the received data;
generating a data association result which is information indicating the presence of relation between the data; and
determining whether or not the factory equipment is in an abnormal state, which is a state other than a normal state which is a state where manufacturing of a product is actually performed, based on the data association result.

12. The abnormal-state detection method according to claim 11, further comprising:
performing a control for preventing an influence of the application on the information processing based on a result of the determination.

13. The abnormal-state detection method according to claim 12, wherein
the information processing apparatus is connected to a user terminal so as to be capable of communicating therewith,
the information processing includes processing of transmitting a notification to the user terminal, and
the prevention control is a control for preventing the transmission of the notification.

14. The abnormal-state detection method according to claim 12, further comprising:
tagging the received data if the factory equipment is determined to be in the abnormal state, and
performing a control for preventing the tagged data as a target.

15. The abnormal-state detection method according to claim 11, further comprising:
storing information indicating a behavior of the information processing in the normal state, and
determining whether or not the factory equipment is in the abnormal state by comparing information acquired by running the information processing while inputting the received data and information indicating the behavior in the normal state if it is not possible to determine whether or not the factory equipment is in the abnormal state based on the data association result.
